(19) United States
(12) Patent Application Publication
(10) Pub. No.: US 2026/0338950 A1
(43) Pub. Date: Oct. 29, 2026

(54) APPARATUS FOR DETECTING SPACES AND OBJECTS BASED ON ULTRASOUND

(71) Applicant: GANGNEUNG-WONJU NATIONAL UNIVERSITY INDUSTRY ACADEMY COOPERATION GROUP, Gangneung-si (KR)

(72) Inventors: Sangwook PARK, Gangneung-si (KR); MOUNYA ELHILALI, Baltimore, MD (US)

(73) Assignee: GANGNEUNG-WONJU NATIONAL UNIVERSITY INDUSTRY ACADEMY COOPERATION GROUP, Gangneung-si (KR)

(21) Appl. No.: 19/380,048

(22) Filed: Nov. 5, 2025

(30) Foreign Application Priority Data
Apr. 25, 2025 (KR) 10-2025-0054893

(51) Int. Cl. G01S 15/931; G01S 7/521; G01S 7/539

(52) U.S. Cl. CPC G01S 15/931; G01S 7/521; G01S 7/539

(57) ABSTRACT

A detection system mounted on a mobile object for detecting a space and an object based on ultrasonic waves according to the present disclosure may include a sonar detection device mounted on the mobile object and configured to transmit transmission waves that are ultrasonic waves and receive reflection waves reflected from a detection object in response to the transmission waves; and a signal-processing control device mounted on the mobile object and configured to generate object type data indicating the type of detection object using the reflection waves and the reflection waves.

### CROSS-REFERENCE TO RELATED APPLICATION(S)

This application claims the benefit under 35 USC 119(a) of Korean Patent Application No. KR 10-2025-0054893, filed on Apr. 25, 2025 in the Korean Intellectual Property Office, the disclosure of which is incorporated herein by reference in its entirety.

### TECHNICAL FIELD

The present disclosure relates to a detection system mounted on a mobile object for detecting a space and an object based on ultrasonic waves, and more specifically, to a detection system that enables an unmanned mobile object to rapidly and accurately detect an unknown space and object while moving through an unknown space, by transmitting transmission waves that are ultrasonic waves to a detection object, receiving reflection waves reflected from the detection object, generating object type data indicating the type of detection object based on at least one of phase difference data indicating a phase difference between the transmission waves and the reflection waves and reflectivity data indicating a reflectivity that is a ratio of energy of the reflection waves to energy of the transmission waves, and generating separation distance data based on a round-trip time data indicating a time difference between a transmission point in time of the transmission waves and a reception point in time of the reflection waves, in a state in which the detection system is mounted on the mobile object.

### BACKGROUND

Generally, ultrasonic sensors of two types including a piezoelectric type and a magnetostrictive type are mainly used.

A piezoelectric sensor uses a phenomenon in which a voltage is induced when pressure is applied to an object such as quartz crystal, piezoelectric material (PZT), or piezoelectric polymer, and conversely, vibration occurs when a voltage is applied, and a magnetostrictive sensor uses a Joule effect (a phenomenon in which vibration occurs when a magnetic field is applied) and a Villari effect (a phenomenon in which a magnetic field is generated when stress is applied) in an alloy such as iron, nickel, and cobalt.

In an ultrasonic sensor, an element with piezoelectric and electrostrictive properties is used as a vibration source, rapid vibrations occur at the number of times equal to a high frequency when electrical energy at the high-frequency is applied to such a ceramic element, and in this case, a piezoelectric ceramic element generates ultrasonic waves in a specific frequency band that is inaudible to humans due to vibrations when the applied frequency is 20 kHz or higher.

In particular, a sensor using a piezoelectric element uses ultrasonic waves for sensing, and the sensor intermittently transmits an ultrasonic pulse signal and receives reflection waves from a nearby obstacle to detect an object.

However, ultrasonic sensor technology in the related art is limited to detecting an object or measuring a distance to the object, and lacks the ability to identify the type of unknown object.

### PRIOR ART DOCUMENT

### Patent Document

(Patent Document 1) Korean Patent Publication No. 10-2002-0096847

### SUMMARY

An object of the present disclosure is to provide a detection system that enables an unmanned mobile object to rapidly and accurately detect an unknown space and object while moving through an unknown space, by transmitting transmission waves that are ultrasonic waves to a detection object, receiving reflection waves reflected from the detection object, generating object type data indicating the type of detection object based on at least one of phase difference data indicating a phase difference between the transmission waves and the reflection waves and reflectivity data indicating a reflectivity that is a ratio of energy of the reflection waves to energy of the transmission waves, and generating separation distance data based on a round-trip time data indicating a time difference between a transmission point in time of the transmission waves and a reception point in time of the reflection waves, in a state in which the detection system is mounted on the mobile object.

The objects of the present disclosure are not limited to the above-mentioned objects, and other objects and advantages of the present disclosure that are not mentioned may be understood through the following description and will be more clearly understood by referring to the embodiments of the present disclosure. Further, it will be readily understood that the objects and advantages of the present disclosure may be realized by the means and combinations thereof set forth in the claims.

A detection system mounted on a mobile object for detecting a space and an object based on ultrasonic waves according to the present disclosure may include a sonar detection device mounted on the mobile object and configured to transmit transmission waves that are ultrasonic waves and receive reflection waves reflected from a detection object in response to the transmission waves; and a signal-processing control device mounted on the mobile object and configured to generate object type data indicating the type of detection object using the reflection waves and the reflection waves.

The sonar detection device may include one or more ultrasonic sensors configured to transmit the ultrasonic waves and receive the reflection wave; and a housing including a fixing portion formed on an outer surface of the housing for installation on an outer surface of the mobile object, and one or more sensor holes formed therethrough, one or more ultrasonic sensors being installed in the sensor holes.

The signal-processing control device may include a housing installed on an outer surface of the mobile object or accommodated in a housing of the mobile object.

When a detection request signal is received from the mobile object or an external device, the signal-processing control device may transmit, to the sonar detection device, a sonar detection control signal for controlling the sonar detection device so that the sonar detection device transmits the transmission waves and receive the reflection waves.

The signal-processing control device may calculate at least one of phase difference data indicating a phase difference between the transmission waves and the reflection waves, and reflectivity data indicating a reflectivity, which is a ratio of energy of the reflection waves to energy of the transmission waves, and generate object type data indicating the type of detection object based on the at least one of the calculated phase difference data and the calculated reflectivity data.

The signal-processing control device may input at least one of the phase difference data and the reflectivity data as input data to an artificial intelligence model trained to analyze the phase difference data for each frequency and determine the type of detection object, and receive the object type data, which is a result of determining the type of detection object, as output data from the artificial intelligence model.

The signal-processing control device may calculate round-trip time data indicating a time difference between a transmission point in time of the transmission waves and a reception point in time of the reflection waves, and generate separation distance data indicating a separation distance from the detection system to the detection object based on the round-trip time data.

According to the present disclosure, it is possible for the mobile object to rapidly and accurately detect an unknown space and object while moving through an unknown space, by transmitting transmission waves that are ultrasonic waves to a detection object, receiving reflection waves reflected from the detection object, generating object type data indicating the type of detection object based on at least one of phase difference data indicating a phase difference between the transmission waves and the reflection waves and reflectivity data indicating a reflectivity that is a ratio of energy of the reflection waves to energy of the transmission waves, and generating separation distance data based on a round-trip time data indicating a time difference between a transmission point in time of the transmission waves and a reception point in time of the reflection waves, in a state in which the detection system is mounted on the mobile object.

### BRIEF DESCRIPTION OF THE DRAWINGS

FIG. 1 is a perspective view of a detection system mounted on a mobile object for detecting a space and an object based on ultrasonic waves in a state in which the detection system is mounted on the mobile object according to an embodiment of the present disclosure.

FIG. 2 is a perspective view of the detection system mounted on the mobile object for detecting a space and an object based on the ultrasonic waves according to the embodiment of the present disclosure, which is separated from the mobile object.

FIG. 3 is a block diagram of the detection system mounted on a mobile object for detecting a space and an object based on ultrasonic waves according to the embodiment of the present disclosure.

FIG. 4 is a diagram illustrating a process of training an artificial intelligence model used in the detection system mounted on a mobile object for detecting a space and an object based on ultrasonic waves according to the embodiment of the present disclosure.

FIG. 5 is a diagram illustrating a process of generating object type data using an artificial intelligence model in the detection system mounted on a mobile object for detecting a space and an object based on ultrasonic waves according to an embodiment of the present disclosure.

### DETAILED DESCRIPTION

Hereinafter, various embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included. In the description of the drawings, similar components may be denoted by similar reference numerals.

In the present disclosure, expressions such as “have,” “may have,” “include,” and “may include” indicate the presence of corresponding features (for example, a numerical value, function, operation, or component such as a part) and do not exclude the presence of additional features.

In the present disclosure, expressions such as “A or B,” “at least one of A and/or B,” or “one or more of A or/and B” may include all possible combinations of listed items. For example, “A or B,” “at least one of A and B,” or “at least one of A or B” may all refer to (1) including at least one A, (2) including at least one B, or (3) including both at least one A and at least one B.

As used in the present disclosure, expressions such as “first” and “second may describe various components regardless of order and/or importance, and are used only to distinguish one component from another without limiting the components. For example, a first user device and a second user device may represent different user devices regardless of order or importance. As another example, a first component may be referred to as a second component, and similarly, a second component may be referred to as a first component without departing from the scope of the rights set forth in the present disclosure.

When a component (for example, a first component) is said to be “(operatively or communicatively) coupled with/to” or “connected to” another component (for example, a second component), it should be understood that the component may be directly connected to the other component or may be connected via another component (for example, a third component). On the other hand, when a component (for example, a first component) is said to be “directly connected” or “directly coupled” to another component (for example, a second component), it may be understood that no other component (for example, a third component) exists between the component and the other component.

As used in the present disclosure, the expression “configured to” may be used interchangeably with, for example, “suitable for,” “having the capacity to,” “designed to,” “adapted to,” “made to,” or “capable of” The term “configured (set) to” does not necessarily mean “specifically designed to” in terms of hardware. Instead, in a certain situation, the expression “a device configured to do” may mean that the device is “capable of” doing something together with other devices or components. For example, “a control unit configured (or set) to perform A, B, and C” may be a dedicated processor (for example, an embedded processor) for performing operations, or a general-purpose processor (for example, a CPU or application processor) capable of performing operations by executing one or more software programs stored in a memory.

In particular, in the present disclosure, “~module” and “~device” may include one or more of a central processing unit (CPU), an application processor (AP), and a communication processor (CP).

In the present disclosure, “~module” and “~device” refer to any type of hardware device including at least one processor, and may be understood to encompass software components operating on the hardware device in some embodiment.

The terms used in the present disclosure are solely for the purpose of describing specific embodiments and may not be intended to limit the scope of other embodiments. Singular expressions may include plural expressions unless the context clearly dictates otherwise. Terms used herein, including technical or scientific terms, have the same meaning as commonly understood by those skilled in the art described in the present disclosure. Terms defined in general dictionaries among terms used in the present disclosure may be construed as having the same or similar meaning in the context of the related art, and shall not be construed in an idealized or overly formal sense unless explicitly defined in the present disclosure. In some cases, even when a term is defined in the present disclosure, the term should not be construed to exclude embodiments of the present disclosure.

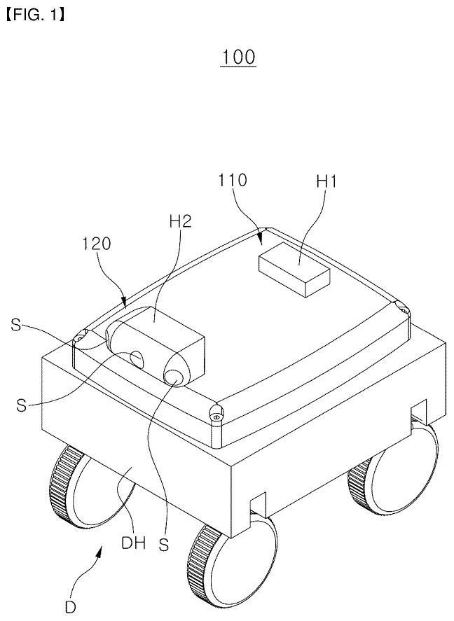

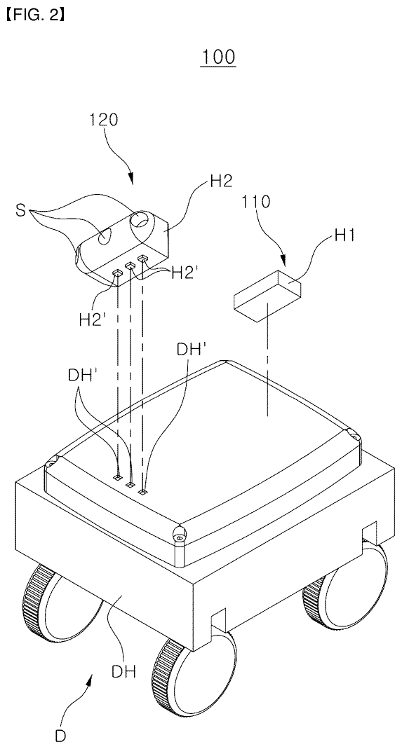

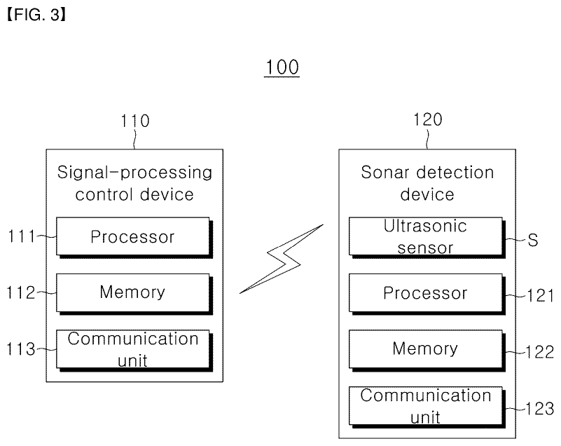

FIG. 1 is a perspective view of a detection system mounted on a mobile object for detecting a space and an object based on ultrasonic waves in a state in which the detection system is mounted on the mobile object according to an embodiment of the present disclosure, FIG. 2 is a perspective view of the detection system mounted on the mobile object for detecting a space and an object based on the ultrasonic waves according to the embodiment of the present disclosure, which is separated from the mobile object, and FIG. 3 is a block diagram of the detection system mounted on a mobile object for detecting a space and an object based on ultrasonic waves according to the embodiment of the present disclosure.

Referring to FIGS. 1 to 3, a detection system 100 mounted on a mobile object for detecting a space and an object based on ultrasonic waves according to the embodiment of the present disclosure (hereinafter referred to as a “detection system”) may be a system that detects spaces and objects using ultrasonic wave while moving through an unknown space in a state in which the detection system is mounted on a mobile object D.

Here, the mobile object D may be an unmanned or manned device. For example, the mobile object D may be any of an aerial drone, a maritime drone, or a land drone.

The mobile object D may also be a device that moves unmanned in a disaster area or the like and search for or rescue survivors.

In this case, the detection system 100 mounted on the above-described mobile object D transmits transmission wave, which are ultrasonic wave, to an unknown space and object to be detected, and receives reflection wave reflected from the object to detect the space and object.

To this end, the detection system 100 may include a signal-processing control device 110 and a sonar detection device 120.

That is, the signal-processing control device 110 and the sonar detection device 120 may be mounted on the mobile object D.

For example, the signal-processing control device 110 and the sonar detection device 120 may be installed and mounted on an upper surface of a mobile object housing DH of the mobile object D.

Alternatively, only the sonar detection device 120 may be installed and mounted on the upper surface of the mobile object housing DH of the mobile object D, and the signal-processing control device 110 may be accommodated and mounted inside the mobile object housing DH of the mobile object D.

In this case, the signal-processing control device 110 and the sonar detection device 120 may be mounted on the mobile object D but positioned to be spaced apart from each other to perform wired and wireless communication with each other.

Further, the signal-processing control device 110 may perform wired or wireless communication with the mobile object D or an external device. Here, the external device may be a device that remotely controls the detection system 100 or the mobile object D.

Hereinafter, a detection operation of the detection system 100 will be described.

The signal-processing control device 110 may include a housing H1 that accommodates internal components.

The housing H1 may be installed on the upper surface of the mobile object housing DH of the mobile object D or accommodated and mounted inside the mobile object housing DH of the mobile object D.

Meanwhile, when a detection request signal is received from the mobile object D or the external device, the signal-processing control device 110 may transmit, to the sonar detection device 120, a sonar detection control signal for controlling the sonar detection device 120 so that the sonar detection device 120 transmits a transmission wave and receives a reflection wave.

Here, the detection request signal is a signal for requesting the detection system 100 to perform detection, and the detection request may request the detection system 100 to detect a space and an object. Specifically, the detection request may be a request for causing the detection system 100 to generate at least one of separation distance data indicating a separation distance from a detection object and object type data indicating the type of detection object.

Meanwhile, when the sonar detection device 120 receives the sonar detection control signal, the sonar detection device 120 may transmit a transmission wave and receive a reflection wave, which is the transmission wave reflected from the detection object.

To this end, the sonar detection device 120 may include one or more ultrasonic sensors S that transmit ultrasonic waves and receive reflection waves.

In this case, the sonar detection device 120 may further include a housing H2 that accommodates internal components.

Specifically, the housing H2 of the sonar detection device 120 may have a fixing portion H2′ formed on an outer surface thereof so that the housing H2 is installed on an outer surface of the mobile object D, and may have one or more sensor holes formed therethrough, into which one or more ultrasonic sensors may be installed.

The fixing portion H2′ may include a plurality of fastening protrusions H2′ formed to protrude downward from a lower surface of the housing H2.

Accordingly, a plurality of fastening grooves DH′ into which the plurality of fastening protrusions H2′ are fitted may be formed in a recessed manner on the upper surface of the mobile object housing DH.

This makes it possible for the sonar detection device 120 to be mounted on the mobile object D.

Meanwhile, the housing H2 may include a plurality of sensor holes formed therethrough in a central portion and left and right portions of a front surface, and a plurality of ultrasonic sensor S may be installed in the plurality of sensor holes, respectively.

Alternatively, the housing H2 may include a single sensor hole formed therethrough, and one ultrasonic sensor S may be installed in the sensor hole.

Meanwhile, the transmission waves transmitted by the ultrasonic sensors S may be ultrasonic waves having a plurality of frequencies.

That is, when the sonar detection device 120 receives the sonar detection control signal, a plurality of ultrasonic sensors S may transmit transmission waves, which are a plurality of ultrasonic waves having different frequencies.

Here, the frequency of the transmission wave may be a frequency within a preset frequency range. Here, the preset frequency range may be from 20 kHz to 150 kHz.

For example, when the sonar detection device 120 receives the sonar detection control signal, each of the plurality of ultrasonic sensors S transmits a first transmission wave that is an ultrasonic wave having a frequency of 20 kHz and receives a first reflection wave corresponding to the first transmission wave, transmits a second transmission wave that is an ultrasonic wave having a frequency of 30 kHz and receives a second reflection wave corresponding to the second transmission wave, transmits a third transmission wave that is an ultrasonic wave having a frequency of 40 kHz and receives a third reflection wave corresponding to the third transmission wave, transmits a fourth transmission wave that is an ultrasonic wave having a frequency of 50 kHz and receives a fourth reflection wave corresponding to the fourth transmission wave, transmits a fifth transmission wave that is an ultrasonic wave having a frequency of 60 kHz and receives a fifth reflection wave corresponding to the fifth transmission wave, transmits a sixth transmission wave that is an ultrasonic wave having a frequency of 70 kHz and receives a sixth reflection wave corresponding to the sixth transmission wave, transmits a seventh transmission wave that is an ultrasonic wave having a frequency of 80 kHz and receives a seventh reflection wave corresponding to the seventh transmission wave, transmits an eighth transmission wave that is an ultrasonic wave having a frequency of 90 kHz and receives an eighth reflection wave corresponding to the eighth transmission wave, transmits a ninth transmission wave that is an ultrasonic wave having a frequency of 100 kHz and receives a ninth reflection wave corresponding to the ninth transmission wave, transmits a tenth transmission wave that is an ultrasonic wave having a frequency of 110 kHz and receives a tenth reflection wave corresponding to the tenth transmission wave, transmits an 11-th transmission wave that is an ultrasonic wave having a frequency of 120 kHz and receives an 11-th reflection wave corresponding to the 11-th transmission wave, transmits a 12-th transmission wave that is an ultrasonic wave having a frequency of 130 kHz and receives a 12-th reflection wave corresponding to the 12-th transmission wave, transmits a 13-th transmission wave that is an ultrasonic wave having a frequency of 140 kHz and receives a 13-th reflection wave corresponding to the 13-th transmission wave, and transmits a 14-th transmission wave that is an ultrasonic wave having a frequency of 150 kHz and receives a 14-th reflection wave corresponding to the 14-th transmission wave.

In the above-described example, frequencies of a plurality of transmission waves have been described as being different in units of 10 kHz, but various frequencies of the transmission waves may be set within a preset frequency range.

Meanwhile, the ultrasonic sensor S of the sonar detection device 120 may transmit the transmission wave so that the energy of the transmission wave becomes preset energy. In this case, the preset energy may be changed.

Thereafter, the ultrasonic sensor S of the sonar detection device 120 may output reflection wave data representing a received reflection wave to the signal-processing control device 110.

Further, the ultrasonic sensor S of the sonar detection device 120 may also transmit transmission wave data representing the transmission wave to the signal-processing control device 110.

Further, the ultrasonic sensor S of the sonar detection device 120 may also transmit the above-described preset reference energy, which is the energy of the transmission wave, to the signal-processing control device 110.

The signal-processing control device 110 may generate at least one of phase difference data representing a phase difference between the transmission waves and the reflection waves, and reflectivity data representing a reflectivity that is a ratio of the energy of the reflection wave to the energy of the transmission wave.

To this end, the signal-processing control device 110 may perform signal processing, including amplification, noise control, and digital conversion, on the transmission wave data and the reception wave data.

Thereafter, the signal-processing control device 110 may input the transmission wave data and the reflection wave data to a phase difference calculation algorithm to generate the phase difference data.

Further, the signal-processing control device 110 may input the reflection wave data to an ultrasonic energy calculation algorithm to calculate the energy of the reflection waves, and calculate, as reflectivity data, a reflectivity that is a value obtained by dividing the energy of the reflection waves by a set energy that is the energy of the transmission wave.

Thereafter, the signal-processing control device 110 may generate the object type data representing the type of detection object, based on at least one of the phase difference data and the reflectivity data.

Continuing with the above-described example, the signal-processing control device 110 may individually generate the at least one of the phase difference data and the reflectivity data for the first to 14-th transmission waves and the first to 14-th reflection waves.

Specifically, the signal-processing control device 110 may generate the at least one of the phase difference data and the reflectivity data for the first transmission wave and the first reflection wave, generate the at least one of the phase difference data and the reflectivity data for the second transmission wave and the second reflection wave, and repeatedly perform this process up to the 14-th transmission wave and the 14-th reflection wave.

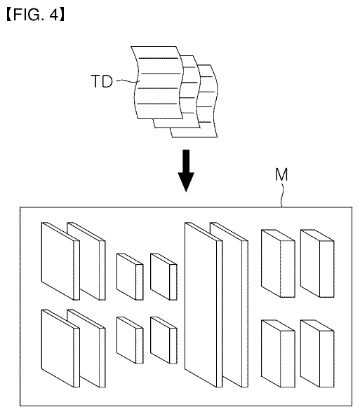

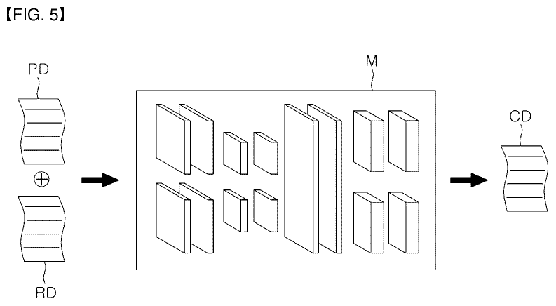

FIG. 4 is a diagram illustrating a process of training an artificial intelligence model used in the detection system mounted on a mobile object for detecting a space and an object based on ultrasonic waves according to the embodiment of the present disclosure, and FIG. 5 is a diagram illustrating a process of generating the object type data using an artificial intelligence model in the detection system mounted on a mobile object for detecting a space and an object based on ultrasonic waves according to an embodiment of the present disclosure.

Referring back to FIGS. 4 and 5, the signal-processing control device 110 may generate object type data CD indicating the type of detection object based on at least one of phase difference data PD and reflectivity data RD.

Specifically, the signal-processing control device 110 may generate the object type data CD using an artificial intelligence model M.

In this case, for the signal-processing control device 110 to generate the object type data CD using the artificial intelligence model M, the artificial intelligence model M may be trained in advance.

Specifically, the artificial intelligence model M may be trained to analyze at least one of the phase difference data PD and the reflectivity data RD described above by frequency using training data TD and determine the type of detection object.

According to an embodiment, the training data TD may include training phase difference data for training transmission wave transmitted toward a training detection object of a predetermined type and a training reflection waves received by the training transmission wave being reflected from the training detection object, training the object type data indicating the type of training detection object, and training frequency data indicating a frequency of the training transmission wave.

That is, according to an embodiment, the training data TD may be data in which training phase difference data for each of a plurality of pieces of training frequency data is mapped to a plurality of pieces of training the object type data, as shown in Table 1 below.

TABLE 1

| Training Object | Training | Training Phase |
|---|---|---|
| Type Data | Frequency Data | Difference Data |
| Leaf | 20 kHz | 0 |
| | 30 kHz | ¼λ |
| | 40 kHz | 0 |
| | . . . | . . . |
| Concrete Wall | 20 kHz | 0 |
| | 30 kHz | 0 |
| | 40 kHz | 0 |
| | . . . | . . . |

Meanwhile, according to another embodiment, the training data TD may include training reflectivity data for the training transmission wave and the training reflection wave, training the object type data, and training frequency data.

That is, according to another embodiment, the training data TD may be data in which training reflectivity data for each of a plurality of pieces of training frequency data is mapped to the plurality of pieces of training the object type data, as shown in Table 2 below.

TABLE 2

| Training Object | Training | Training |
|---|---|---|
| Type Data | Frequency Data | Reflectivity Data |
| Leaf | 20 kHz | 70% |
| | 30 kHz | 50% |
| | 40 kHz | 80% |
| | . . . | . . . |
| Concrete Wall | 20 kHz | 98% |
| | 30 kHz | 98% |
| | 40 kHz | 98% |
| | . . . | . . . |

Meanwhile, according to another embodiment, the training data TD may include training phase difference data for the training transmission wave and the training reflection wave, the training reflectivity data for the training transmission wave and the training reflection wave, training the object type data, and the training frequency data.

That is, according to another embodiment, the training data TD may be data in which training phase difference data and training reflectivity data for each of the plurality of pieces of training frequency data are mapped to the plurality of pieces of training the object type data, as shown in Table 3 below.

TABLE 3

| Training Object | Training | Training Phase | Training |
|---|---|---|---|
| Type Data | Frequency Data | Difference Data | Reflectivity Data |
| Leaf | 20 kHz | 0 | 70% |
| | 30 kHz | ¼λ | 50% |
| | 40 kHz | 0 | 80% |
| | . . . | . . . | . . . |

. . .

| | | | |
|---|---|---|---|
| Concrete Wall | 20 kHz | 0 | 98% |
| | 30 kHz | 0 | 98% |
| | 40 kHz | 0 | 98% |
| | . . . | . . . | . . . |

That is, the artificial intelligence model M may learn a pattern in which a phase difference and a reflectivity for the transmission wave and the reception wave vary for each frequency of the transmission wave depending on the type of detection object, determine the type of detection object based on input phase difference data PD and input reflectivity data RD when at least one of the phase difference data PD and the reflectivity data RD is input, and output a determined result as the object type data CD.

In this case, the signal-processing control device 110 may input at least one of the phase difference data PD and the reflectivity data RD acquired from the sonar detection device 120 as input data to the artificial intelligence model M and receive the object type data CD, which is a result of determining the type of detection object, as output data from the artificial intelligence model M.

Specifically, the signal-processing control device 110 may input only the phase difference data PD acquired from the sonar detection device 120 as the input data to the artificial intelligence model M and receive the object type data CD as the output data from the artificial intelligence model M.

Alternatively, the signal-processing control device 110 may input only the reflectivity data RD acquired from the sonar detection device 120 as the input data to the artificial intelligence model M and receive the object type data CD as the output data from the artificial intelligence model M.

Alternatively, the signal-processing control device 110 may input both the phase difference data PD and the reflectivity data RD acquired from the sonar detection device 120 as the input data to the artificial intelligence model M and receive the object type data CD as the output data from the artificial intelligence model M.

Meanwhile, the signal-processing control device 110 may calculate round-trip time data indicating a time difference between a transmission point in time of the transmission waves and a reception point in time of the reflection waves, and generate separation distance data indicating a separation distance from the detection system to the detection object based on the round-trip time data.

Thereafter, the signal-processing control device 110 may transmit the generated phase difference data PD, reflectivity data RD, and separation distance data to the mobile object D or the external device.

Meanwhile, the signal-processing control device 110 according to another embodiment may classify each of a plurality of candidate object types into one of a plurality of error groups based on s detection error rate of each of the plurality of candidate object types.

Specifically, the signal-processing control device 110 may set a detection error rate range for each of the plurality of error groups so that the detection error rate ranges do not overlap between the plurality of error groups, and may classify the candidate object type into an error group corresponding to a detection error rate range within which a detection error rate of the candidate object type falls.

For example, the plurality of error groups may include four groups including first to fourth error groups, a detection error rate range of the first error group may be 0% or more and less than 25%, a detection error rate range of the second error group may be 25% or more and less than 50%, the detection error rate range of the third error group may be 50% or more and less than 75%, and the detection error rate range of the fourth error group may be 75% or more and 100% or less.

Here, the candidate object type may be a candidate of an object type that may be represented by the object type data.

Further, the detection error rate may be a ratio of the number of pieces of object type data representing an object type that is not the same as the candidate object type among the generated object type data, to a plurality of times the object type data is generated for a detection object of which the type is the candidate object type.

Meanwhile, the signal-processing control device 110 may set the number of re-detections for each of the plurality of error groups. In this case, the signal-processing control device 110 may set a larger number of re-detections when a minimum or maximum value of the detection error rate range of the error group increases.

For example, the number of re-detections is set to 0 for the first error group, the number of re-detections is set to 1 for the second error group, the number of re-detections is set to 3 for the third error group, and the number of re-detections is set to 5 for the fourth error group.

In this case, the signal-processing control device 110 may perform measurement of the detection error rate for each of the plurality of candidate object types and classification of error groups according to the detection error rate before performing detection of an unknown detection object. A result of classifying the error group and a result of setting the number of re-detections may be stored in a memory as re-detection reference data.

When the object type data is initially generated (output) in response to the detection request signal, the signal-processing control device 110 may search the re-detection reference data for the same candidate object type as the object type indicated by the initially generated object type data, and check the number of re-detections set for the error group that includes the candidate object type that has been searched for.

Thereafter, the signal-processing control device 110 may output the number of re-detections to the sonar detection device 120, and the sonar detection device 120 and the signal-processing control device 110 may perform the re-detection as many times as the number of re-detections by repeating the transmission of the transmission waves, reception of the reflection waves, calculation of the phase difference data PD, calculation of the reflectivity data RD, input of the phase difference data PD and the reflectivity data RD to the artificial intelligence model M, and output of the object type data from the artificial intelligence model M so that the object type data for the detection object is additionally generated as many times as the number of re-detections.

Subsequently, the signal-processing control device 110 may determine that a most common object type among the object types indicated by the object type data according to the re-detections is a final type of detection object.

Meanwhile, the signal-processing control unit 110 may confirm whether the object type indicated by the object type data generated in response to the detection request signal is the same as the final object type determined through the re-detection, and classify the error group into which the same candidate object type as the corresponding object type is classified, into a lower error group that is one level lower than an existing error group when the number of times the object type indicated by the object type data generated in response to the detection request signal is continuously the same as the final object type determined through the re-detection reaches a reference number of times.

For example, the reference number of times may be 5, but may be set to any value.

Here, the lower error group may be an error group of which a detection error rate range is lower than that of an upper error group.

This allows the signal-processing control unit 110 to reclassify the candidate object type into the lower error group and minimize unnecessary re-detection when a detection result in response to the detection request signal is the same as a detection result obtained by the re-detection consecutively for the reference number of times.

Meanwhile, referring back to FIG. 3, the signal-processing control device 110 may include a processor 111, a memory 112, and a communication unit 113.

The processor 111 controls an overall operation of the signal-processing control device 110. Specifically, the processor 111 may be connected to a configuration of the signal-processing control device 110 including the memory 112 as described above, and may control the overall operation of the signal-processing control device 110 by executing at least one instruction stored in the memory 112 as described above. In particular, the processor 111 may be implemented as a single processor 111 or may be implemented as a plurality of processors 111.

The processor 111 may be implemented in various ways. For example, the one or more processors 111 may include one or more of a central processing unit (CPU), a graphics processing unit (GPU), an accelerated processing unit (APU), a many integrated core (MIC), a digital signal processor (DSP), a neural processing unit (NPU), a hardware accelerator, and a machine learning accelerator. The one or more processors 111 may control one or any combination of other components of the signal-processing control device 110 and may perform operations related to communication or data processing. The one or more processors 111 may execute one or more programs or instructions stored in the memory 112. For example, the one or more processors 111 may perform a method according to the embodiment of the present disclosure by executing one or more instructions stored in the memory 112.

In embodiments of the present disclosure, the processor 111 may be a system on a chip SoC in which one or more processors 111 and other electronic components are integrated, a single-core processor 111, a multi-core processor 111, or a core included in the single-core processor 111 or the multi-core processor 111, and the core may be implemented as a CPU, a GPU, an APU, a MIC, a DSP, an NPU, a hardware accelerator, a machine learning accelerator, or the like, but the embodiments of the present disclosure are not limited thereto.

When the method according to the embodiment of the present disclosure includes a plurality of operations, the plurality of operations may be performed by one processor 111 or may be performed by a plurality of processors 111. For example, when a first operation, a second operation, and a third operation are performed by using the method according to the embodiment, the first operation, the second operation, and the third operation may all be performed by a first processor 111, or the first and second operations may be performed by the first processor 111 (for example, a general-purpose processor 111), and the third operation may be performed by a second processor 111 (for example, an artificial intelligence-dedicated processor 111).

The one or more processors 111 may be implemented as a single-core processor 111 including one core, or may be implemented as one or more multi-core processors 111 including a plurality of cores (for example, homogeneous multi-cores or heterogeneous multi-cores). When the one or more processors 111 are implemented as a multi-core processor 111, each of a plurality of cores included in the multi-core processor 111 may include an internal memory 112 of the processor 111, such as an on-chip memory 112, and a common cache shared by the plurality of cores may be included in the multi-core processor 111. Further, each of the plurality of cores (or some of the plurality of cores) included in the multi-core processor 111 may independently read and execute program instructions for implementing the method according to the embodiment of the present disclosure, or all (or some) of the plurality of cores may be linked to read and execute the program instructions for implementing the method according to the embodiment of the present disclosure.

When the method according to the embodiment of the present disclosure includes a plurality of operations, the plurality of operations may be performed by one of the plurality of cores included in the multi-core processor 111 or may be performed by the plurality of cores. For example, when first, second, and third operations are performed using the method according to the embodiment, the first, second, and third operations may all be performed by a first core included in a multi-core processor 111, or the first and second operations may be performed by the first core included in the multi-core processor 111 and the third operation may be performed by a second core included in the multi-core processor 111.

The processor 111 may perform operations using an output value from the artificial intelligence model.

The artificial intelligence model may be constructed in consideration of an application field of the recognition model, the purpose of learning, or the computer performance of the device. Further, the artificial intelligence model may be, for example, a neural network-based model.

The artificial intelligence model may be designed to simulate a structure of a human brain on a computer. The artificial intelligence model may include a plurality of network nodes with weights that simulate neurons in a human neural network. The plurality of network nodes may establish a connection relationship to simulate a synaptic activity of neurons that exchange signals through synapses.

The artificial intelligence model may include, for example, a neural network model or a deep learning model developed from the neural network model. In the deep learning model, a plurality of network nodes may be located at different depths (or layers) and may exchange data based on a convolutional connection relationship. For example, models such as a deep neural network (DNN), a recurrent neural network (RNN), or a bidirectional recurrent deep neural network (BRDNN) may be used as the artificial intelligence model, but the present disclosure are not limited thereto.

A deep learning model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of two or more of the networks, but is not limited to the examples described above. The artificial intelligence model may additionally or alternatively include a software structure in addition to a hardware structure.

The deep learning model may include a learning algorithm. For example, the deep learning model may include supervised learning, unsupervised learning, semi-supervised learning, or reinforcement learning, but is not limited to the examples described above. The artificial intelligence model may include a plurality of artificial neural network layers.

The memory 112 may store various programs or data temporarily or non-temporarily and transfers stored information to the processor 111 according to a call from the processor 111. Further, the memory 112 may store various information necessary for calculation, processing, or control operations of the processor 111 in an electronic format.

The memory 112 may include, for example, at least one of a main memory device and an auxiliary memory device. The main memory device may be implemented using a semiconductor storage medium such as a ROM and/or a RAM. The ROM may include, for example, a typical ROM, an EPROM, an EEPROM, and/or a MASK-ROM. The RAM may include, for example, a DRAM and/or a SRAM. The auxiliary storage device may be implemented using at least one storage medium capable of permanently or semi-permanently storing data, such as a flash memory 112, a secure digital (SD) card, a solid state drive (SSD), a hard disk drive (HDD), or an optical recording medium such as a magnetic drum, a compact disc (CD), a DVD, or a laser disc, a magnetic tape, a magneto-optical disc, and/or a floppy disk.

The memory 112 may store an artificial intelligence model, output data acquired based on input data input to the artificial intelligence model, usage information acquired based on the output data, and reconstruction information for reconstructing the acquired artificial intelligence model based on the usage information.

The communication unit 113 may include at least one of a wireless communication interface and a wired communication interface. The wireless communication interface may perform communication with various external devices using wireless communication technology or mobile communication technology. The wireless communication technology may include, for example, Bluetooth, Bluetooth Low Energy, CAN communication, Wi-Fi, Wi-Fi Direct, ultrawideband (UWB) communication, Zigbee, infrared data association (IrDA), or near field communication (NFC), and the mobile communication technology may include, for example, 3GPP, Wi-Max, Long Term Evolution (LTE), and 5G.

The wireless communication interface may be implemented by using an antenna, a communication chip, a substrates, or the like capable of transmitting electromagnetic waves to the outside or receiving electromagnetic waves transferred from outside.

The wired communication interface may perform communication with various devices based on a wired communication network. Here, the wired communication network may be implemented, for example, using physical cables, such as paired cables, coaxial cables, fiber optic cables, or Ethernet cables.

The signal-processing control device 110 is not limited to including one communication unit 113 that performs a single type of communication connection, and may include a plurality of communication units 113 that perform a plurality of types of communication connections.

The sonar detection device 120 may include a processor 121, a memory 122, and a communication unit 123.

The processor 121 controls an overall operation of the sonar detection device 120. Specifically, the processor 121 may be connected to a configuration of the sonar detection device 120 including the memory 122 as described above, and may control the overall operation of the sonar detection device 120 by executing at least one instruction stored in the memory 122 as described above. In particular, the processor 121 may be implemented as a single processor 121 or may be implemented as a plurality of processors 121.

The processor 121 may be implemented in various ways. For example, the one or more processors 121 may include one or more of a central processing unit (CPU), a graphics processing unit (GPU), an accelerated processing unit (APU), a many integrated core (MIC), a digital signal processor (DSP), a neural processing unit (NPU), a hardware accelerator, and a machine learning accelerator. The one or more processors 121 may control one or any combination of other components of the sonar detection device 120 and may perform operations related to communication or data processing. The one or more processors 121 may execute one or more programs or instructions stored in the memory 122. For example, the one or more processors 121 may perform the method according to the embodiment of the present disclosure by executing one or more instructions stored in the memory 122.

In embodiments of the present disclosure, the processor 121 may be a system on a chip SoC in which one or more processors 121 and other electronic components are integrated, a single-core processor 121, a multi-core processor 121, or a core included in the single-core processor 121 or the multi-core processor 121, and the core may be implemented as a CPU, a GPU, an APU, a MIC, a DSP, an NPU, a hardware accelerator, a machine learning accelerator, or the like, but the embodiments of the present disclosure are not limited thereto.

When the method according to the embodiment of the present disclosure includes a plurality of operations, the plurality of operations may be performed by one processor 121 or may be performed by a plurality of processors 121. For example, when a first operation, a second operation, and a third operation are performed by the method according to an embodiment, the first operation, the second operation, and the third operation may all be performed by a first processor 121, or the first operation and the second operation may be performed by the first processor 121 (for example, a general-purpose processor 121) and the third operation may be performed by a second processor 121 (for example, an artificial intelligence-dedicated processor 121).

The one or more processors 121 may be implemented as a single-core processor 121 including one core, or may be implemented as one or more multi-core processors 121 including a plurality of cores (for example, homogeneous multi-cores or heterogeneous multi-cores). When the one or more processors 121 are implemented as a multi-core processor 121, each of a plurality of cores included in the multi-core processor 121 may include an internal memory 122 of the processor 121, such as an on-chip memory 122, and a common cache shared by the plurality of cores may be included in the multi-core processor 121. Further, each of the plurality of cores (or some of the plurality of cores) included in the multi-core processor 111 may independently read and execute program instructions for implementing the method according to the embodiment of the present disclosure, or all (or some) of the plurality of cores may be linked to read and execute the program instructions for implementing the method according to the embodiment of the present disclosure.

When the method according to the embodiment of the present disclosure includes a plurality of operations, the plurality of operations may be performed by one of the plurality of cores included in the multi-core processor 121 or may be performed by the plurality of cores. For example, when first, second, and third operations are performed using the method according to the embodiment, the first, second, and third operations may all be performed by a first core included in a multi-core processor 121, or the first and second operations may be performed by the first core included in the multi-core processor 121 and the third operation may be performed by a second core included in the multi-core processor 121.

The memory 122 may store various programs or data temporarily or non-temporarily and transfers stored information to the processor 121 according to a call from the processor 121. Further, the memory 122 may store various information necessary for calculation, processing, or control operations of the processor 121 in an electronic format.

The memory 122 may include, for example, at least one of a main memory device and an auxiliary memory device. The main memory device may be implemented using a semiconductor storage medium such as a ROM and/or a RAM. The ROM may include, for example, a typical ROM, an EPROM, an EEPROM, and/or a MASK-ROM. The RAM may include, for example, a DRAM and/or a SRAM. The auxiliary storage device may be implemented using at least one storage medium capable of permanently or semi-permanently storing data, such as a flash memory 122, a secure digital (SD) card, a solid state drive (SSD), a hard disk drive (HDD), or an optical recording medium such as a magnetic drum, a compact disc (CD), a DVD, or a laser disc, a magnetic tape, a magneto-optical disc, and/or a floppy disk.

The communication unit 123 may include at least one of a wireless communication interface and a wired communication interface. The wireless communication interface may perform communication with various external devices using wireless communication technology or mobile communication technology. The wireless communication technology may include, for example, Bluetooth, Bluetooth Low Energy, CAN communication, Wi-Fi, Wi-Fi Direct, ultrawideband (UWB) communication, Zigbee, infrared data association (IrDA), or near field communication (NFC), and the mobile communication technology may include, for example, 3GPP, Wi-Max, Long Term Evolution (LTE), and 5G.

The wireless communication interface may be implemented by using an antenna, a communication chip, a substrates, or the like capable of transmitting electromagnetic waves to the outside or receiving electromagnetic waves transferred from outside.

The wired communication interface may perform communication with various devices based on a wired communication network. Here, the wired communication network may be implemented, for example, using physical cables, such as paired cables, coaxial cables, fiber optic cables, or Ethernet cables.

The sonar detection device 120 is not limited to including one communication unit 123 that performs a single type of communication connection, and may include a plurality of communication units 123 that perform a plurality of types of communication connections.

The preferred embodiments of the present disclosure has been mainly described. It will be understood by those skilled in the art that the present disclosure may be implemented in modified forms without departing from essential characteristics of the present disclosure. Therefore, the disclosed embodiments should be considered illustrative rather than restrictive. The scope of the present disclosure is determined by the claims, not the foregoing description, and all differences within the scope equivalent thereto should be construed as being encompassed by the present disclosure.

Although the present disclosure has been described above through limited embodiments and drawings, the present disclosure is not limited thereto and it will be apparent to those skilled in the art that various modifications and variations can be made without departing from the technical spirit of the present disclosure and the equivalent scope of the claims set forth below.

### DESCRIPTION OF REFERENCE NUMERALS

100: Detection system mounted on mobile object for detecting space and object based on ultrasonic waves
110: Signal-processing control device
120: Sonar detection device

What is claimed is:

1. A detection system mounted on a mobile object for detecting a space and an object based on ultrasonic waves, the detection system comprising:
a sonar detection device mounted on the mobile object and configured to transmit transmission waves that are ultrasonic waves and receive reflection waves reflected from a detection object in response to the transmission waves; and
a signal-processing control device mounted on the mobile object and configured to generate object type data indicating the type of detection object using the reflection waves and the reflection waves.

2. The detection system of claim 1, wherein the sonar detection device includes
one or more ultrasonic sensors configured to transmit the ultrasonic waves and receive the reflection wave; and
a housing including a fixing portion formed on an outer surface of the housing for installation on an outer surface of the mobile object, and one or more sensor holes formed therethrough, one or more ultrasonic sensors being installed in the sensor holes.

3. The detection system of claim 1, wherein the signal-processing control device includes a housing installed on an outer surface of the mobile object or accommodated in a housing of the mobile object.

4. The detection system of claim 1, wherein, when a detection request signal is received from the mobile object or an external device, the signal-processing control device transmits, to the sonar detection device, a sonar detection control signal for controlling the sonar detection device so that the sonar detection device transmits the transmission waves and receive the reflection waves.

5. The detection system of claim 1, wherein the signal-processing control device calculates at least one of phase difference data indicating a phase difference between the transmission waves and the reflection waves, and reflectivity data indicating a reflectivity, which is a ratio of energy of the reflection waves to energy of the transmission waves, and generates object type data indicating the type of detection object based on the at least one of the calculated phase difference data and the calculated reflectivity data.

6. The detection system of claim 5, wherein the signal-processing control device inputs at least one of the phase difference data and the reflectivity data as input data to an artificial intelligence model trained to analyze the phase difference data for each frequency and determine the type of detection object, and receives the object type data, which is a result of determining the type of detection object, as output data from the artificial intelligence model.

7. The detection system of claim 1, wherein the signal-processing control device calculates round-trip time data indicating a time difference between a transmission point in time of the transmission waves and a reception point in time of the reflection waves, and generates separation distance data indicating a separation distance from the detection system to the detection object based on the round-trip time data.
